(19) United States
(12) Patent Application Publication
(10) Pub. No.: US 2026/0063904 A1
(43) Pub. Date: Mar. 5, 2026

(54) HEAD-MOUNTED DISPLAY DEVICE

(71) Applicant: HTC Corporation, Taoyuan City (TW)

(72) Inventors: Li-Hsun Chang, Taoyuan City (TW); Kuan-Ying Ou, Taoyuan City (TW)

(73) Assignee: HTC Corporation, Taoyuan City (TW)

(21) Appl. No.: 19/232,875

(22) Filed: Jun. 10, 2025

Related U.S. Application Data
(60) Provisional application No. 63/687,744, filed on Aug. 27, 2024.

(51) Int. Cl. G02B 27/01

(52) U.S. Cl. CPC G02B 27/0172; G02B 2027/0132; G02B 2027/0178

(57) ABSTRACT

A head-mounted display device includes a body and two optical lens sets. The optical lens sets are installed in the body and correspond to two lens seats of the body. When a lens is assembled to the lens seat of the body, a combining portion of lens pushes away and passes through an elastic retraction portion of a combining portion of the lens seat, the elastic retraction portion is restored, the combining portion of the lens is assembled with the combining portion of the lens seat, and a gap is maintained between the lens and the optical lens set.

### CROSS-REFERENCE TO RELATED APPLICATION

This application claims the priority benefit of U.S. provisional application Ser. No. 63/687,744, filed on Aug. 27, 2024. The entirety of the above-mentioned patent application is hereby incorporated by reference herein and made a part of this specification.

### TECHNICAL FIELD

The application relates to a head-mounted display device, and more particularly to a head-mounted display device that allows a user to self-prepare corrective lenses for use.

### DESCRIPTION OF RELATED ART

With the rapid advancement of current technology, the types and the functions of head-mounted display devices are becoming increasingly diverse. Taking an augmented reality head-mounted display device as an example, if a user has common vision problems such as myopia, hyperopia, or astigmatism, when wearing the augmented reality head-mounted display device, a pair of vision corrective lenses must be prepared and placed on a lens frame, and then the lens frame must be assembled to the device to be located between the device and the eyes of the user. When different users use the same augmented reality head-mounted display device, the users must also replace with the suitable vision corrective lenses and lens frames, and the assembly issue between the lens frames and the device also affect the vision correction effect.

### SUMMARY

The application provides a head-mounted display device, which can improve the inconvenience of combining with vision corrective lenses self-prepared by a user.

A head-mounted display device of the application includes a body, a first optical lens set, and a second optical lens set. The body has a first lens seat and a second lens seat, respectively used to accommodate a first lens and a second lens corresponding to both eyes. An inner sidewall of the first lens seat has a first combining portion. An inner sidewall of the second lens seat has a second combining portion. The first combining portion includes a first elastic retraction portion. The second combining portion includes a second elastic retraction portion. A sidewall of the first lens has a third combining portion. A sidewall of the second lens has a fourth combining portion. The first optical lens set is installed in the body and corresponds to the first lens seat. The second optical lens set is installed in the body and corresponds to the second lens seat. When the first lens is assembled to the first lens seat, after the third combining portion of the first lens pushes away and passes through the first elastic retraction portion, the first elastic retraction portion is restored, the third combining portion is combined with the first combining portion, and a gap is maintained between the first lens and the first optical lens set. When the second lens is assembled to the second lens seat, after the fourth combining portion of the second lens pushes away and passes through the second elastic retraction portion, the second elastic retraction portion is restored, the fourth combining portion is combined with the second combining portion, and a gap is maintained between the second lens and the second optical lens set.

Based on the above, in the head-mounted display device of the application, the lens seat is combined with the body, so there is no issue of assembly and alignment between the lens seat and the body, and the lens may be fixed in an appropriate position through the design of the combining portion.

### BRIEF DESCRIPTION OF THE DRAWINGS

FIG. 1 is a schematic view of a head-mounted display device according to an embodiment of the invention.

FIG. 2 is a partial perspective view of the head-mounted display device of FIG. 1.

FIG. 3 is a schematic view after a lens in FIG. 2 is removed.

FIG. 4 is a schematic view after a part of a body in FIG. 2 is removed.

FIG. 5 and FIG. 6 are partial cross-sectional schematic views of the head-mounted display device of FIG. 1 when the lens is assembled.

FIG. 7 and FIG. 8 are partial schematic views of a lifting portion in FIG. 3 before and after retraction.

FIG. 9 to FIG. 11 are partial cross-sectional schematic views of the head-mounted display device of FIG. 1 when three other different lenses are installed.

### DESCRIPTION OF THE EMBODIMENTS

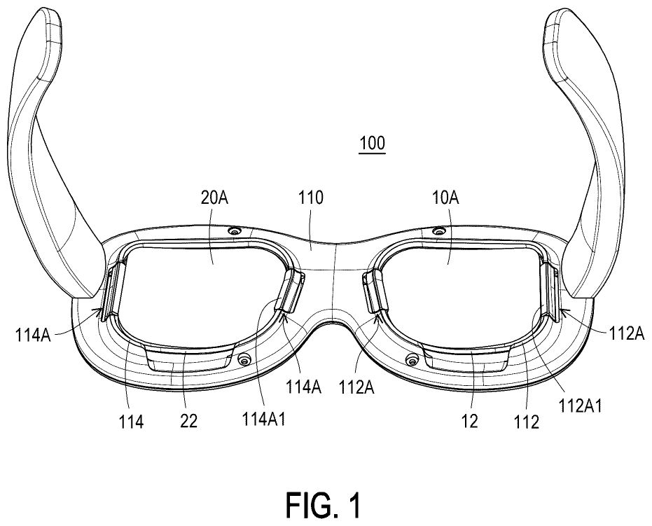

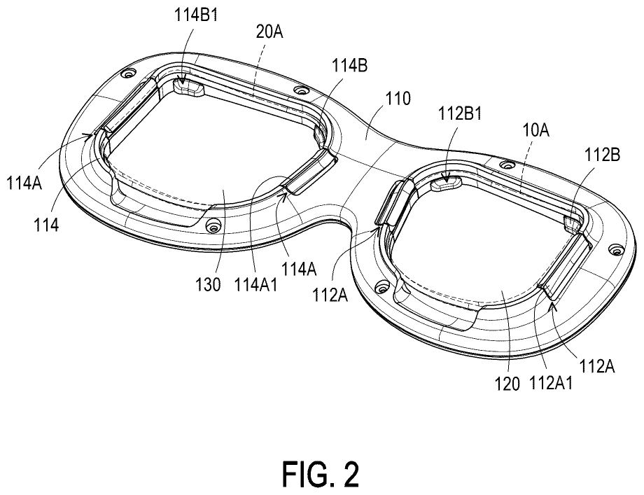

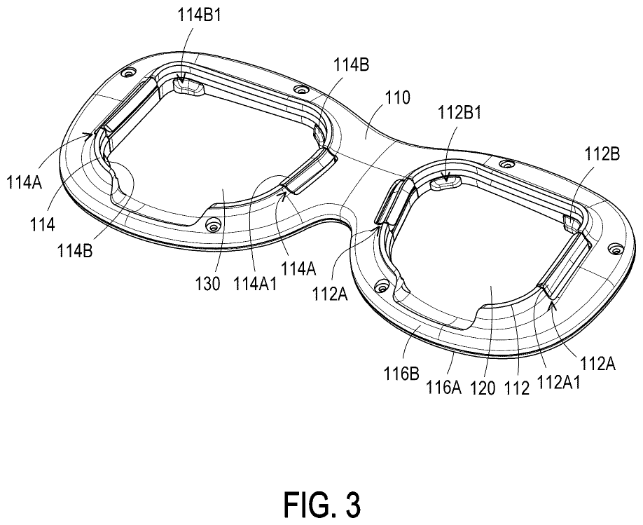

FIG. 1 is a schematic view of a head-mounted display device according to an embodiment of the invention. FIG. 2 is a partial perspective view of the head-mounted display device of FIG. 1. Temples shown in FIG. 1 are not the focus of the application and are therefore removed in subsequent drawings. In FIG. 2, a first lens 10A and a second lens 20A are presented in dotted lines and a perspective manner to facilitate understanding of the relative relationship between the first lens 10A and the second lens 20A and other elements thereunder. FIG. 3 is a schematic view after the lenses in FIG. 2 are removed. Please refer to FIG. 1, FIG. 2, and FIG. 3. A head-mounted display device 100 of the embodiment includes a body 110, a first optical lens set 120 and a second optical lens set 130. The body 110 has a first lens seat 112 and a second lens seat 114 respectively used to accommodate the first lens 10A and the second lens 20A corresponding to both eyes.

In the embodiment, the body 110 may be, for example, applied to fields such as a virtual reality system, an augmented reality system, or a mixed reality system. The body 110 may include components such as a display and a protective housing. The display may be a built-in display or an external portable display (for example, a smart phone, etc.), but the application is not limited thereto. The first optical lens set 120 and the second optical lens set 130 include optical elements used to change light paths of the display, such as lenses, light guides, prisms, other elements, or a combination thereof. The body 110 in FIG. 1 is presented in the form of light and thin glasses, but the body 110 may also be in the form of having a slightly larger volume or other forms with even larger volumes.

An inner sidewall of the first lens seat 112 has a first combining portion 112A. An inner sidewall of the second lens seat 114 has a second combining portion 114A. The first combining portion 112A includes a first elastic retraction portion 112A1. The second combining portion 114A includes a second elastic retraction portion 114A1. A sidewall of the first lens 10A has a third combining portion 12. A sidewall of the second lens 20A has a fourth combining portion 22. The first optical lens set 120 is installed in the body 110 and corresponds to the first lens seat 112. The second optical lens set 130 is installed in the body 110 and corresponds to the second lens seat 114.

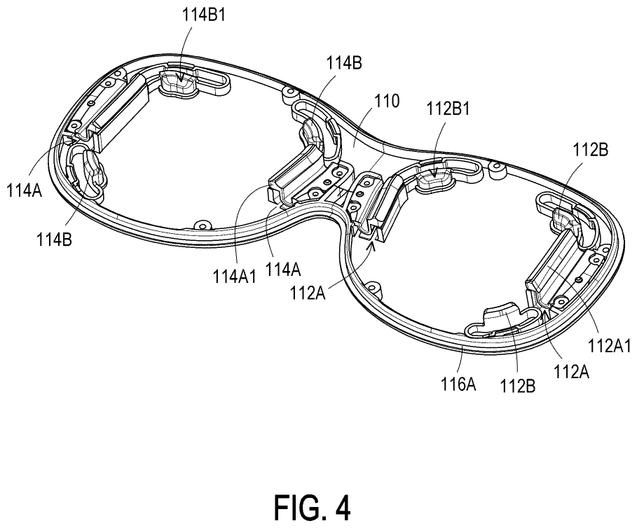

FIG. 4 is a schematic view after a part of the body in FIG. 2 is removed. Please refer to FIG. 3 and FIG. 4. The body 110 of the embodiment further includes, for example, a first case 116A and a second case 116B. In FIG. 4, the second case 116B is removed to clearly see the first combining portion 112A and the second combining portion 114A disposed on the first case 116A. In the embodiment, the number of the first combining portions 112A and the second combining portions 114A is both two, which are respectively located on two opposite sides of the first lens seat 112 and the second lens seat 114. A fixed end of the first elastic retraction portion 112A1 is fixed to the first case 116A. A part of the first elastic retraction portion 112A1 used to contact the first lens 10A is a free end, and the free end is connected to the fixed end in a U-shaped structure. Therefore, the free end of the first elastic retraction portion 112A1 used to contact the first lens 10A may be pushed and may be restored after an external force is removed. The structure of the second elastic retraction portion 114A1 is substantially the same as that of the first elastic retraction portion 112A1.

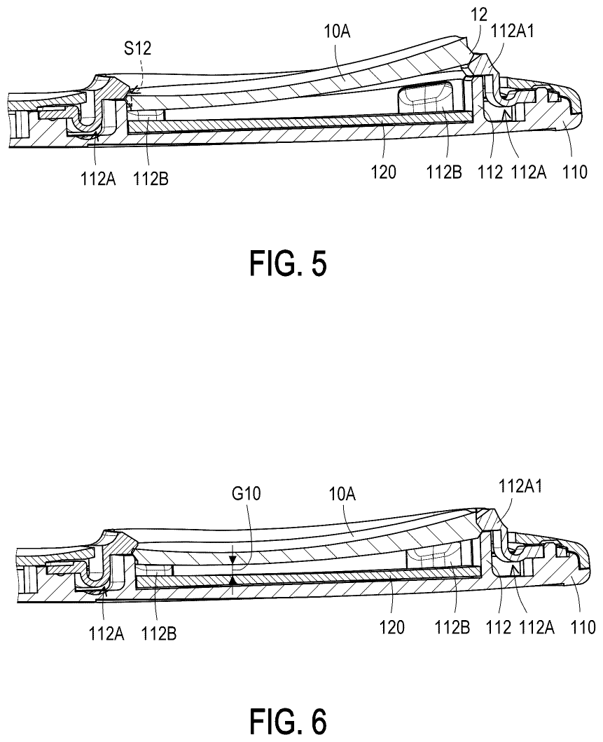

FIG. 5 and FIG. 6 are partial cross-sectional schematic views of the head-mounted display device of FIG. 1 when the lens is assembled. Please refer to FIG. 5 and FIG. 6. When the first lens 10A is assembled to the first lens seat 112, the first lens 10A is firstly placed on the first lens seat 112 approximately horizontally. Then, a side of the first lens 10A is pressed, so that the third combining portion 12 on the side pushes away and passes through the first elastic retraction portion 112A1. Then, the first elastic retraction portion 112A1 is restored by an elastic restoring force. Likewise, according to the same steps, the other side of the first lens 10A is pressed, so that the third combining portion 12 passes through the first elastic retraction portion 112A1. At this time, the third combining portions 12 on two sides are both combined with the first combining portions 112A. Furthermore, a gap G10 is maintained between the first lens 10A and the first optical lens set 120 so as not to contact each other.

Similarly, when the second lens 20A is assembled to the second lens seat 114, the fourth combining portion 22 of the second lens 20A pushes the second elastic retraction portion 114A1, so that the fourth combining portion 22 of the second lens 20A may pass through the second elastic retraction portion 114A1. Then, the second elastic retraction portion 114A1 is restored by an elastic restoring force. At this time, the fourth combining portion 22 is combined with the second combining portion 114A. Furthermore, the gap G10 is maintained between the second lens 20A and the second optical lens set 130 so as not to contact each other.

In this way, the first lens 10A and the first optical lens set 120 and the second lens 20A and the second optical lens set 130 may be prevented from being damaged by friction, and light leakage and light energy loss caused by the contact between the two may also be prevented. On the other hand, if the gap G10 is too large and not limited, thicker corrective lenses may be used, which may further increase the distance between the first optical lens set 120 and the second optical lens set 130 and the human eyes, resulting in a narrowed field of vision, and the human eyes may easily see the edges of the first optical lens set 120 and the second optical lens set 130, reducing the user experience. Therefore, using the head-mounted display device 100 of the embodiment may ensure that the gap G10 is small enough, which can obtain a sufficiently large field of view to improve the user experience.

In the head-mounted display device 100 of the embodiment, the first lens seat 112 and the second lens seat 114 are originally disposed on the body 110, so the user does not need to assemble the first lens seat 112 and the second lens seat 114 to the body 110, nor does the user need to perform alignment. The combination of a third combining portion 10C and the first combining portion 112A enables the assembly and the positioning between the first lens 10A and the first lens seat 112 to be easy. The combination of a fourth combining portion 20D and the second combining portion 114B enables the assembly and the positioning between the second lens 20A and the second lens seat 114 to be easy.

In the embodiment, a cross section S12 of a space where the first combining portion 112A is used to be combined with the third combining portion 12 is a triangle, but the application is not limited thereto. In other words, a cross section of the third combining portion 12 is also a corresponding triangle. Similarly, a cross section of a space where the second combining portion 114A is used to be combined with the fourth combining portion 22 may also be a triangle.

The first lens 10A and the second lens 20A are not part of the head-mounted display device 100 of the embodiment. That is, when the user obtains the head-mounted display device 100 of the embodiment, the first lens 10A and the second lens 20A are not included. Because the head-mounted display device 100 is designed for all users, the head-mounted display device 100 does not have a function that may adapt to vision correction requirements of individual users. If the user has vision problems such as myopia, hyperopia, or astigmatism, the user may self-prepare the first lens 10A and the second lens 20A with a corresponding vision correction function to be installed on the first lens seat 112 and the second lens seat 114, so as to obtain a better visual experience. When other users use the head-mounted display device 100, because different users require different vision correction effects, the new users may self-prepare the first lens 10A and the second lens 20A with the suitable vision correction function to be installed on the first lens seat 112 and the second lens seat 114, so as to obtain a better visual experience.

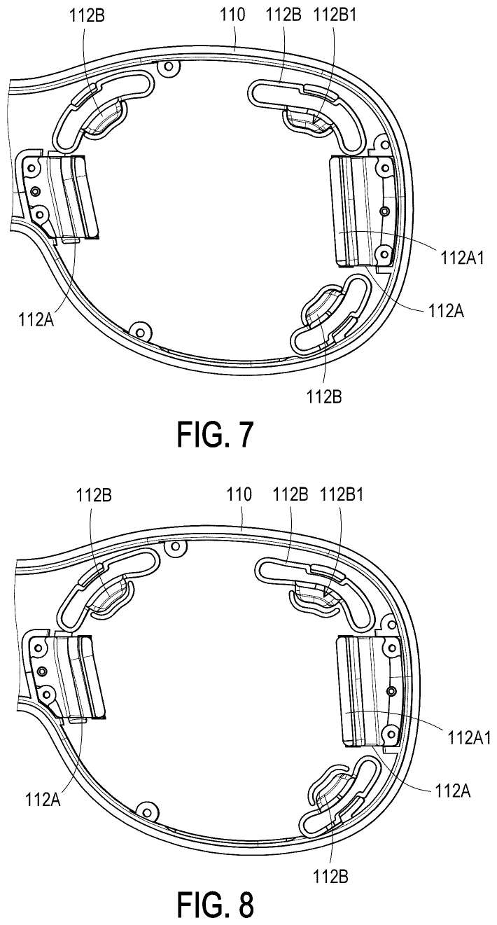

FIG. 7 and FIG. 8 are partial schematic views of a lifting portion in FIG. 3 before and after retraction. Please refer to FIG. 2, FIG. 5, FIG. 7, and FIG. 8. In the embodiment, the inner sidewall of the first lens seat 112 further has a first lifting portion 112B. The inner sidewall of the second lens seat 114 further has a second lifting portion 114B. When the first lens 10A is assembled to the first lens seat 112, a side of the first lens 10A away from the third combining portion 12 first enters the first lens seat 112, and the first lifting portion 112B contacts the first lens 10A to maintain a gap with the first optical lens set 120. The presence of the first lifting portion 112B may prevent the user from applying excessive force in the first assembly step, causing a side of the first lens 10A to be stuck in a position that is too low, which makes it impossible to engage the other side of the first lens 10A into the first combining portion 112A in the subsequent assembly step. Furthermore, due to the presence of the first lifting portion 112B, the user may be prevented from allowing the first lens 10A to directly contact the first optical lens set 120 below in the first assembly step, so as to ensure that the first lens 10A and the first optical lens set 120 are not damaged by friction.

Similarly, when the second lens 20A is assembled to the second lens seat 114, a side of the second lens 20A away from the fourth combining portion 22 first enters the second lens seat 114, and the second lifting portion 114B contacts the second lens 20A to maintain a gap with the second optical lens set 130. Due to the presence of the second lifting portion 114B, smooth assembly may be ensured and damage caused by friction between the second lens 20A and the second optical lens set 130 may be prevented.

In the embodiment, the first lifting portion 112B and the second lifting portion 114B are elastically retractable, as shown in FIG. 8. Therefore, when the first lens 10A and the second lens 20A are assembled, the first lens 10A may be prevented from being damaged by excessive contact force between the first lens 10A and the first lifting portion 112B, and the second lens 20A may also be prevented from being damaged by excessive contact force between the second lens 20A and the second lifting portion 114B. Furthermore, even if different sizes of the first lens 10A and the second lens 20A are used due to individual differences of users, the first lifting portion 112B and the second lifting portion 114B may also be elastically retracted to appropriate positions, thus having better dimensional compatibility.

In the embodiment, a surface 112B1 of the first lifting portion 112B used to contact the first lens 10A and a surface 114B1 of the second lifting portion 114B used to contact the second lens 20A are inclined surfaces. Therefore, the first lifting portion 112B and the second lifting portion 114B may be further prevented from causing damage to the first lens 10A and the second lens 20A. In the embodiment, the number of the first lifting portions 112B and the second lifting portions 114B is three, but the application is not limited thereto. In the embodiment, the number of the first combining portions 112A is two, which are located on two opposite sides of the first lens seat 112. The number of the second combining portions 114A is two, which are located on two opposite sides of the second lens seat 114, but the application is not limited thereto.

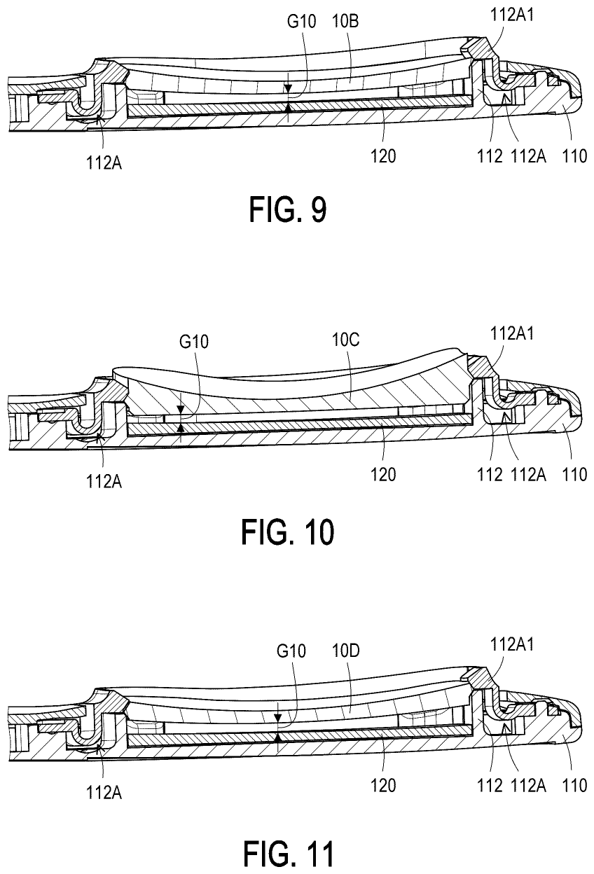

FIG. 9 to FIG. 11 are partial cross-sectional schematic views of the head-mounted display device of FIG. 1 when three other different lenses are installed. Please refer to FIG. 9 to FIG. 11. In the embodiment, when a first lens 10B, a first lens 10C, and a first lens 10D with different optical properties are assembled to the first lens seat 112, the gaps G10 between the first lens 10B, the first lens 10C, and the first lens 10D and the first optical lens set 120 are all the same. When the optical properties of the lenses are different, the geometric dimensions such as the concavities and the thicknesses of the lenses are also different. Under the same corrective optical properties, using a lens with a higher refractive index may produce a corrective lens with a smaller curvature and a thinner thickness. That is, the thickness of the corrective lens changes depending on the correction diopter, the curvatures of the front and back curved surfaces, the diameter, and the refractive index. For example, a myopia corrective lens has an optical property of 400 degrees, a material with a refractive index of 1.6, and an aspherical front curved surface and back curved surface, the maximum edge thickness at a diameter of 75 mm is 6 mm. At this time, if a material with a refractive index of 1.67 is used instead, the maximum edge thickness is 5.1 mm. If a material with a refractive index of 1.74 is used instead, the maximum edge thickness will be reduced to 4.4 mm. However, as long as the distances between the combining portions of the lenses with different optical properties and the most protruding portions of the lenses in the optical axis direction are fixed, after the lenses are assembled to the lens seats, the gaps between the lenses and the optical lens sets remain fixed, so as to provide similar visual experiences, such as similar optical properties or similar fields of view.

In summary, in the head-mounted display device of the application, the lens seat is combined with the body, so there is no issue of assembly and alignment between the lens seat and the body, and the lens may be fixed in an appropriate position through the design of the combining portion. Not only can the user self-prepare the vision corrective lenses to be combined with the head-mounted display device for use, the lenses may also be easily assembled directly to the head-mounted display device to be positioned with the optical lens sets in the device, which is simple and lightweight. In addition, the combining portions of the lens seats allow the gaps between the lenses and the optical lens sets to remain the same or similar when the lenses are installed to the lens seats, so as to provide similar visual experiences, such as similar optical properties or similar fields of view. Furthermore, the lifting portion of the lens seat may also prevent the lens from contacting the optical lens set during the assembly process.

What is claimed is:

1. A head-mounted display device, comprising:
a body, having a first lens seat and a second lens seat, respectively used to accommodate a first lens and a second lens corresponding to both eyes, wherein an inner sidewall of the first lens seat has a first combining portion, an inner sidewall of the second lens seat has a second combining portion, the first combining portion comprises a first elastic retraction portion, the second combining portion comprises a second elastic retraction portion, a sidewall of the first lens has a third combining portion, and a sidewall of the second lens has a fourth combining portion;
a first optical lens set, installed in the body and corresponding to the first lens seat; and
a second optical lens set, installed in the body and corresponding to the second lens seat, wherein
when the first lens is assembled to the first lens seat, after the third combining portion of the first lens pushes away and passes through the first elastic retraction portion, the first elastic retraction portion is restored, the third combining portion is combined with the first combining portion, and a gap is maintained between the first lens and the first optical lens set,
when the second lens is assembled to the second lens seat, after the fourth combining portion of the second lens pushes away and passes through the second elastic retraction portion, the second elastic retraction portion is restored, the fourth combining portion is combined with the second combining portion, and a gap is maintained between the second lens and the second optical lens set.

2. The head-mounted display device according to claim 1, wherein the inner sidewall of the first lens seat further has a first lifting portion, the inner sidewall of the second lens seat further has a second lifting portion, when the first lens is assembled to the first lens seat, a side of the first lens away from the third combining portion first enters the first lens seat, and the first lifting portion contacts the first lens to maintain a gap with the first optical lens set, and when the second lens is assembled to the second lens seat, a side of the second lens away from the fourth combining portion first enters the second lens seat, and the second lifting portion contacts the second lens to maintain a gap with the second optical lens set.

3. The head-mounted display device according to claim 2, wherein the first lifting portion and the second lifting portion are elastically retractable.

4. The head-mounted display device according to claim 2, wherein a surface of the first lifting portion used to contact the first lens and a surface of the second lifting portion used to contact the second lens are inclined surfaces.

5. The head-mounted display device according to claim 2, wherein a number of the first lifting portion and the second lifting portion is three.

6. The head-mounted display device according to claim 1, wherein a number of the first combining portions is two, which are located on two opposite sides of the first lens seat, and a number of the second combining portion is two, which are located on two opposite sides of the second lens seat.

7. The head-mounted display device according to claim 1, wherein when the first lens with different optical properties is assembled to the first lens seat, a gap between the first lens and the first optical lens set is the same.

8. The head-mounted display device according to claim 1, wherein a cross section of a space where the first combining portion is used to be combined with the third combining portion is a triangle.
